(19) United States
(12) Patent Application Publication
(10) Pub. No.: US 2010/0133348 A1
(43) Pub. Date: Jun. 3, 2010

(54) ELECTROCHEMICAL CELL FOR USE IN SMART CARDS

(75) Inventors: Daniel Peat, Southampton (GB); Jennifer Sweeney, Tadley (GB); Chris Wright, Oxfordshire (GB); Philip Andrew Nelson, Southampton (GB)

Correspondence Address: FOLEY & LARDNER LLP, P.O. BOX 80278, SAN DIEGO, CA, 92138-0278, US

(73) Assignee: NANOTECTURE LTD., Southampton (GB)

(21) Appl. No.: 12/447,893

(22) PCT Filed: Oct. 31, 2007
(86) PCT No.: PCT/GB07/04153

§ 371 Date: Feb. 3, 2010

(30) Foreign Application Priority Data
Oct. 31, 2006 (GB) 0621738.4

(51) Int. Cl. G06K 19/067; H01M 2/08

(52) U.S. Cl. 235/492; 429/181

(57) ABSTRACT

An electrochemical cell for a smart is compressible under a pressure not exceeding 4.5 MegaPascal to reduce reversibly its thickness by at least 5% and has at least two external surfaces (3, 4), electrically insulated from each other, which are electrically conducting and are, or are in electrical contact with, respective electrodes (1, 2).

The present invention relates to a design of electrochemical cell for use in smart cards, where there are severe constraints on the volume to be occupied by the cell or cells.

A smart card is defined as any pocketable card with an embedded integrated circuit. As such, the term includes memory cards (which contain non-volatile memory storage components), and microprocessor cards (which contain both memory and microprocessor components), for example certain credit cards and SIM cards, such as are used in mobile telephones. Applications for smart cards are increasing rapidly and, apart from their use as memory cards, credit cards, and SIM cards, they may also be used as debit or ATM cards, electronic wallets, payment cards for a variety of specific purposes, for example, public transport or public telephones, authorisation cards for pay television or access-control or identification cards. Doubtless, other applications will develop. Although smart cards come in many shapes and sizes, commensurate with their different uses, they have in common a relatively small size (credit card size or less), and so have in common a requirement for miniaturisation of their components. In general, a smart card would have a thickness no greater than 5.5 mm (a type II CompactFlash card) or 3.3 mm (a type I CompactFlash card), but more commonly no greater than 2.1 mm (a Secure Digital card). The dimensions of a SIM card are specified in ISO7816-1,2.

In smart cards which contain power sources, contacts between the power sources and their loads can generally be made via tabs which are integral with the power source and which are then joined to the load; or via flat surfaces in electrical contact with the electrodes on the power source and at least one spring or flexible plate contained within the card. This spring or flexible plate is under sufficient compression to ensure good contacts with both of the electrodes of the power source or, in the event of a number of power sources in series, the electrodes at each end of the power source train. In the spring or flexible plate example, any contact with the power source, which is not a spring or a flexible plate, is generally an inflexible flat plate.

Furthermore, in smart cards, electrical connection between non-integrated power sources (i.e. not a microbattery in an integrated circuit) and load circuits is generally made with the use of conducting connection tabs that extend from the power source to a point where contact is made with the load circuit. Fixture of the connection tab to the contact point is usually made by soldering or welding. However in these applications, these tabs consume valuable two and three dimensional space due to their own area and volume and to the requirement for points at which to solder (or otherwise join) these to the circuit. Tabs also need to be electrically insulated from any packaging material surrounding the power source.

Surprisingly, it has been found that certain thin film power sources, unlike button cells etc., can be made sufficiently compressible that it is practicable to seal them or insert them into a smart card under sufficient pressure that it is not necessary to use tabs or to use springs or other means to ensure good contact between the external surface of the power source and a flat plate current collector. Alternatively, pressure can be generated from within, with the same result.

Thus, by way of example, a compressible supercapacitor can be sealed into a smart card between two plates which act as contacts and the pressure applied during sealing is sufficient to ensure good contact between the load and the source. Furthermore any change in dimensions of the smart card after sealing as the card returns to ambient conditions will be compensated by changes in the dimensions of the sufficiently reversible, compressible power source. To attempt this with an incompressible cell, e.g. a button cell, would require a much greater level of dimensional precision.

Accordingly, the present invention consists in an electrochemical cell for use in a smart card, which cell comprises electrodes, electrolyte and a separator, characterised in that the cell is compressible under a pressure not exceeding 100 MegaPascal to reduce reversibly the cell thickness, such that the total cell thickness is reduced by the compression by at least 5%, preferably at least 10%, and that at least two external surfaces of the cell, electrically insulated from each other, are electrically conducting and are, or are in electrical contact with, respective electrodes.

The invention further provides a smart card having a power source which comprises at least one electrochemical cell of the present invention.

The invention still further provides an electrochemical cell comprising electrodes, electrolyte and a separator, characterised in that the cell is sealed by a polymeric material, where a layer of ceramic, graphite or oxide material is introduced between the material comprising the cell body and the seal material.

When we refer to the “external surfaces of the cell”, we mean the faces of the prism/volume within which the electrode assembly is contained. This does not include, for example, tabs extending beyond the envelope defined by this assembly.

This connection system facilitates electrical contact between an electronic circuit in a smart card and the electrochemical cell, which provides power to the circuit. For example, there may be current carrying ‘plates’ or contacts embedded in opposing walls of the smart card void space in which the electrochemical cell resides, and current carrying paths from these plates or contacts to the electrical circuit. The plates or contacts separately make contact with the positive and negative ‘terminals’ of the electrochemical cell. The plates or contacts partially or completely cover the faces of the smart card wall that make contact with the conducting faces of the electrochemical cell. In the event that the faces of the electrochemical cell are sufficiently conducting (as in the case where they consist of nickel foil), the area of the embedded plates may be small, such that the area of contact with the power source is small and current collection from other areas of the power source relies on conduction through the faces of the power source.

The benefit of this approach is that it removes the requirement for an additional assembly step, namely the joining by soldering or welding of the power source to the load. It also saves space within the card and makes the fabrication of the power source simpler, as connection tabs are not required. A further benefit is that the smart card itself gives additional strength to the power source so allowing packaging around the electrochemical cell to be dispensed with, and so increasing the energy density.

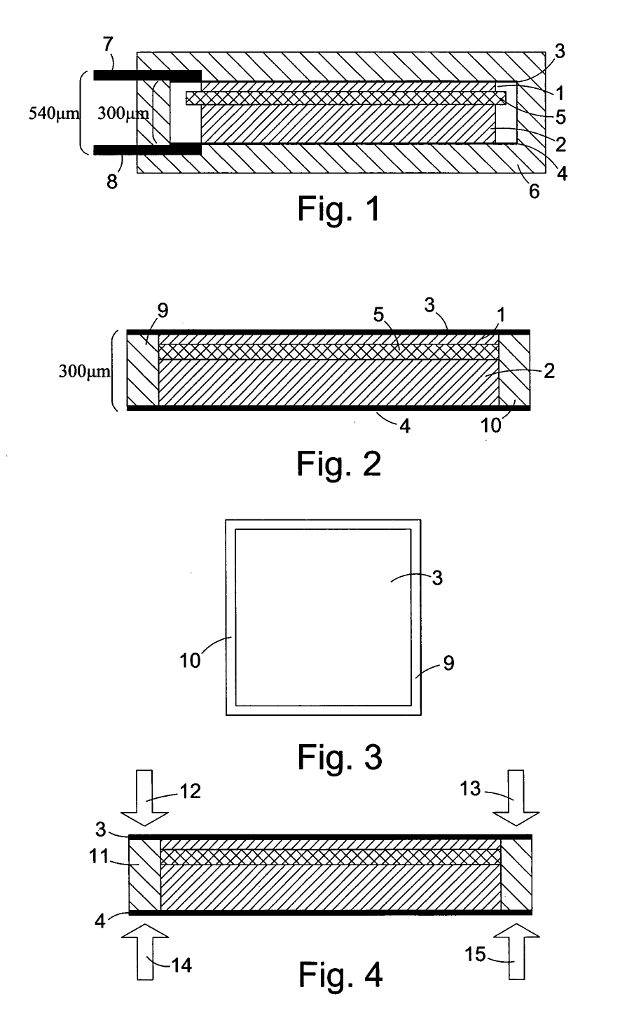

Thus, the cells of the present invention are free from the tabs required in the prior art (i.e. surfaces specifically bonded to the cell to provide electrical contact with the device to be powered by the cell), such as those shown in FIG. 1 of the accompanying drawings, and described in more detail hereafter. The contact needed to provide the power to the device is made directly with the electrode, or, more commonly, the current collector.

The cell should be compressible by at least 5%, and preferably at least 10%, under a pressure not exceeding 100 MegaPascal, more preferably not exceeding 30 MegaPascal, still more preferably not exceeding 20 MegaPascal, and most preferably not exceeding 4.5 MegaPascal. In particular, we find it most useful that the cell should be compressible by at least 5%, and preferably at least 10%, under a pressure not exceeding 1 MegaPascal, more preferably not exceeding 500,000 Pascals, still more preferably 100,000 Pascals, even more preferably 50,000 Pascals and most preferably 10,000 Pascals.

Where there are two or more cells, the overall compressibility of the cells should be within these ranges.

The cells of the present invention should be reversibly compressible under these conditions. That is, after compression, the cell should revert to substantially its original size and shape. However, the reversion need not be 100% complete, provided that it is substantially complete, e.g. at least 75% complete and preferably at least 90% complete.

We prefer that the two external surfaces of the cell should be hermetically sealed to prevent egress of the cell contents. This seal preferably comprises an impermeable, electrically non-conducting polymeric material, which should be resistant to attack and swelling caused by the electrolyte, which can be strongly corrosive (as, for example, a strongly alkaline solution) or can be an organic solvent. The sealant material or materials must also form a strong bond with the material, e.g. nickel foil, forming the external surfaces of the cell that it bridges. Where the sealant material or materials do not inherently form a strong bond with the material that constitutes the external surfaces of the cell, such as in the case where the seal consists of polypropylene and the external cell surface is composed of nickel, an adhesive may be used to promote formation of a strong bond. Examples of suitable sealant materials include curable glues, such as epoxy glues, for example DP-190 and 2216 B/A epoxy from 3M and EP42HT-2 from Masterbond, and thermoplastic polymers, for example polypropylene, polyethylene, acetal or nylon. Examples of suitable adhesives include those listed above.

In some cases the seal or adhesive material in contact with the material that forms the external surface may be electrochemically attacked or corroded or eroded in some way during cell operation. Here, the external surface material, such as nickel foil, may act as a catalyst for oxidation or reduction of the seal or adhesive material for example, may allow gas evolution to occur resulting in mechanical disruption of the interface or may promote some other degradation mechanism. In this case, an extra layer of a material may be used that separates the material being attacked from the external surface material. This layer may be an electrically conductive or non-conductive material, should be chemically stable in the cell environment and should form a strong bond with the two materials it bridges. Further, this material should provide a less catalytically active surface for the above degradation mechanisms, allowing a more durable bond to be produced. Examples of this bridging material include but are not limited to electrically conducting ceramics such as titanium nitride (TiN), non-conducting ceramics, other oxide materials and graphite.

The electrochemical cell in the smart card of the present invention may be a battery, a capacitor or a supercapacitor, and, if a supercapacitor, it may be a symmetric or hybrid supercapacitor. The other parts of the cell are conventional and are chosen having regard to the type of cell which it is desired to produce. The positive electrode may be of any material commonly used in the art for this purpose, preferably: carbon (for example carbon cloth activated carbons or carbon black); silicon carbide; a metal or metal compound, especially a metal, a metal oxide, a metal hydroxide, a metal oxyhydroxide, a metal phosphate or a combination of any two or more of these, or a metal carbide. Examples of such metals include: nickel; alloys of nickel, including alloys or mixtures with a transition metal, nickel/cobalt alloys and mixtures and iron/nickel alloys and mixtures; tin; alloys and mixtures of tin, including alloys and mixtures with a transition metal; iron; manganese; cobalt; titanium; alloys of titanium, including alloys and mixtures with a transition metal; platinum; palladium; lead; alloys of lead, including alloys with a transition metal and ruthenium. Examples of such oxides, hydroxides and oxy-hydroxides include: palladium oxide; nickel oxide (NiO); nickel hydroxide (Ni(OH)₂); nickel oxy-hydroxide (NiOOH); lead dioxide (PbO₂); cobalt oxide (CoO₂) and its lithiated form (LiₓCoO₂); titanium dioxide (TiO₂) and its lithiated form (LiₓTiO₂); titanium oxide (Ti₅O₁₂) and its lithiated form (LiₓTi₅O₁₂) and ruthenium oxide. Of these, we most prefer nickel and its oxides, hydroxides and oxyhydroxides, especially nickel or a nickel/cobalt mixture. An example of a metal carbide is titanium carbide.

The material of which the positive electrode is made may be in any known physical form. For example, it may be porous, especially mesoporous. A mesoporous material which may be used as the positive electrode is preferably formed by a liquid crystal deposition process, such as is described in EP 993 512 or U.S. Pat. No. 6,203,925, the disclosure of which is incorporated herein by reference.

The mesoporous materials which may be used in the present invention are sometimes referred to as “nanoporous”. However, since the prefix “nano” strictly means 10⁻⁹, and the pores in such materials normally range in size from 10⁻⁸ to 10⁻⁹ m, it is better to refer to them, as we do here, as “mesoporous”.

The negative electrode may likewise be of any material commonly used in the art for this purpose, preferably carbon (for example carbon cloth activated carbons or carbon black), silicon carbide, or titanium carbide, or, indeed, any other material, including the others listed above in relation to the positive electrode. The negative electrode may also be made of a mesoporous material or a conventional material.

The electrolyte in the cell is preferably an aqueous electrolyte for a nickel-based hybrid supercapacitor, or an organic electrolyte in the case of a symmetric carbon supercapacitor or a lithium ion battery or a lithium primary battery. A suitable aqueous electrolyte is, for example, an aqueous alkaline electrolyte, such as aqueous potassium hydroxide. A suitable organic electrolyte is, for example, lithium hexafluorophosphate or lithium tetrafluoroborate in ethylene carbonate or propylene carbonate for lithium ion batteries, or tetraethyl ammonium tetrafluoroborate or triethylmethyl ammonium tetrafluoroborate in acetonitrile or propylene carbonate for symmetric carbon supercapacitors.

The separator may be made of any conventional material and its nature is not critical to the present invention. Preferred materials for use as the separator include microporous polypropylene or polyethylene membrane, porous glass fibre tissue or a combination of polypropylene and polyethylene.

The electrodes may be attached to current collectors, which, especially in the case where the electrode is made of a porous material of little mechanical strength, may also act as a support. The nature of the material used for the current collector is not critical to the present invention, except, of course, that it must be electrically conducting and that, where the current collectors form the external surfaces of the cell, they should not be porous, so as to allow a competent seal to be achieved that restricts entry and egress of materials to/from the cell. This material is preferably a metal, for example nickel, copper, aluminium, gold or the like, or a conducting plastic such as that formed by the inclusion of conductive materials into non-conducting polymer matrices. An example of such a material is that obtained by adding conducting nickel filaments into an inherently non-conducting polypropylene matrix. Another example is of materials consisting of carbon nanotubes dispersed within a polyethylene matrix in which the carbon nanotubes provide a conducting pathway through the polymer, so making the material overall conducting. These materials are well known in the art.

For ease of manufacture, the current collector on which the electrode materials sit may be separate elements to the material used to form the external surfaces of the cell. In this case, the cell may be assembled by placing the current collector/electrode piece in contact with the external surface material in a stacked arrangement with, electrical contact between the two provided by compression only or a conductive bond such as that provided by conducting adhesives.

The smart card of the present invention preferably collects power from the electrochemical cell or cells via plates in contact with the external surfaces of the cell or the outermost external surfaces of the cells. Other than this, the construction of the smart card is conventional, and is well known to those skilled in the art. The smart card is preferably no thicker than 5.5 mm, more preferably no thicker than 2 mm, and the electrochemical cell is correspondingly preferably no thicker than 4.5 mm, more preferably no thicker than 1 mm. Still more preferably, the total thickness of the electrochemical cell or cells is no greater than 1 mm, most preferably no greater than 600 μm.

The invention is further illustrated with reference to the accompanying drawings, in which:

FIG. 1 shows a supercapacitor design with tabs, as in the prior art;

FIG. 2 shows schematically a compressible supercapacitor without tabs;

FIG. 3 shows a plan view of a cell in which a seal is applied to the perimeter of the cell;

FIG. 4 shows heat being applied to the perimeter of the cell where the gasket is located;

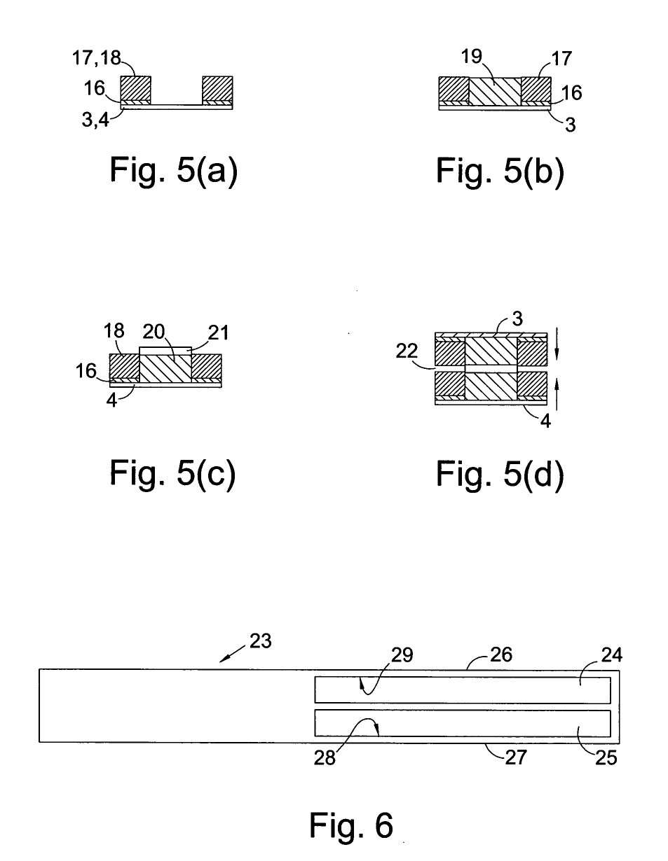

FIG. 5 shows schematically the process for preparing the cell;

FIG. 6 shows a smart card containing an electrochemical cell of the present invention;

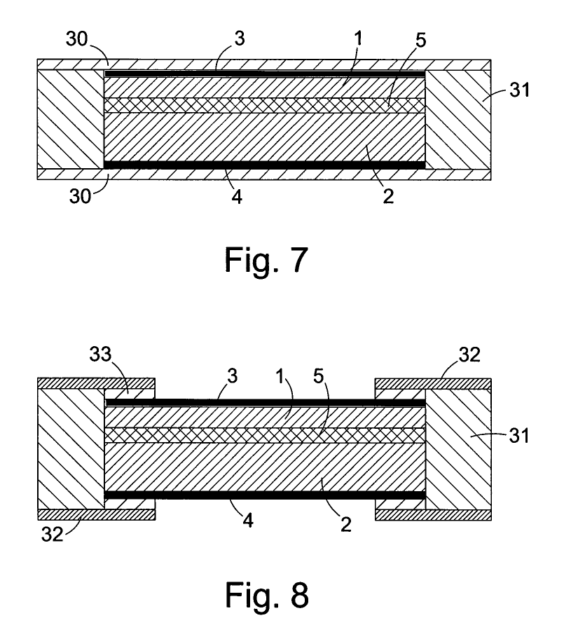

FIGS. 7 & 8 show alternative cell designs in accordance with the present invention; and

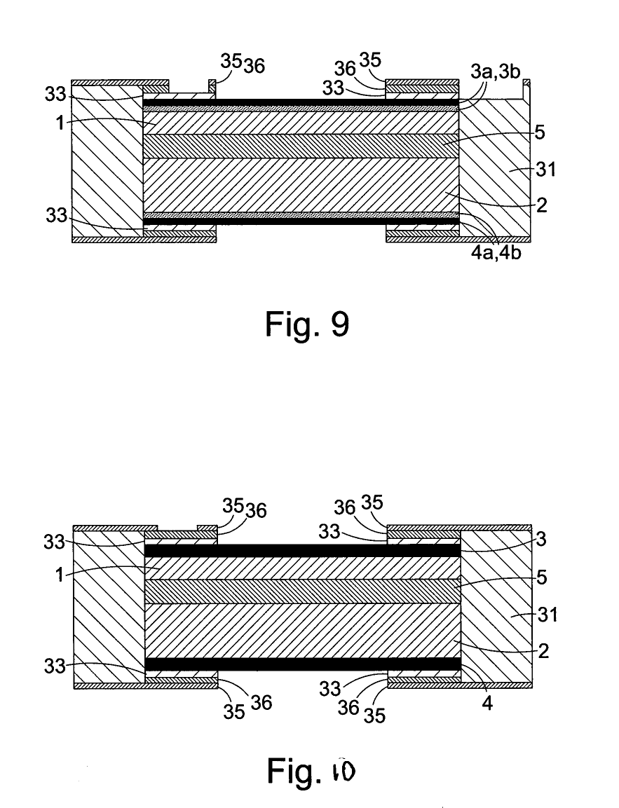

FIGS. 9 to 13 illustrate embodiments of the present invention as made in Examples 2 to 6 and 8 hereafter.

As shown in FIG. 1, a typical supercapacitor comprises: a positive electrode 1, which may, for example, be made of mesoporous nickel; a negative electrode 2, which would commonly be made of carbon; current collectors 3 and 4, which are, for example, nickel foil; separator 5; and electrolyte (not shown). This supercapacitor would normally be encased in a packaging material 6, to provide mechanical strength to the cell and to prevent electrolyte loss from the assembly, just as in batteries. Common packaging materials include, for example, rigid polymer cans and thinner polymer/aluminium/polymer laminates (soft-packs). Extending out of the packaging 6 and connected to the current collectors 3 and 4 is a pair of tabs 7 and 8, which make electrical connection with the circuit using the power.

Typical dimensions of a supercapacitor for use alone are shown on the Figure. However, smart cards require the use of very low profile supercapacitor devices. In smart cards, the supercapacitor is generally required to be no thicker than 600 μm due to the low profile of the card itself. In typical 3 V applications using Ni/C cells (a 1.5 V system), two supercapacitors are required to be used in series. Due to constraints on the footprint of the device, these cells are often required to be stacked on top of each other, further constraining thickness.

In this scenario, the contribution to the device thickness derived from laminate packaging alone would be approximately 480 μm (two cells, packaging each side of each cell, 120 μm laminate thickness) leaving little space for an electrode assembly and resulting in low energy density.

FIGS. 2 and 3 show an example of a compressible supercapacitor without tabs of the present invention. As before, this comprises: a positive electrode 1, which may, for example, be made of mesoporous nickel; a negative electrode 2, which would commonly be made of carbon; current collectors 3 and 4, which are, for example, nickel foil; separator 5; and electrolyte (not shown). Rather than encasing the electrode assembly in packaging as in FIG. 1, however, a hermetic seal 9, 10 is applied to the perimeter of the electrode assembly to prevent egress of electrolyte and ingress of foreign materials. Since the backsides of the nickel foil current collectors remain exposed in the sealed cell, these may be directly used as electrical contacts to carry current out of the device, thus eliminating the need for any tab connection. In this design, the separator may extend into the seal region to anchor it and provide added protection against short circuiting. Contact between the carbon electrode and its current collector is provided by compression alone or the carbon electrode may be adhered to the current collector using a conducting adhesive. Series combinations of cells may be constructed to provide higher voltages simply by stacking cells on top of each other. Since the external faces of the cell act as the terminals, the requirement for additional connections between cells is avoided.

The hermetic seals shown at 9 and 10 consists of an impermeable, non-electrically conducting polymeric material. It must be resistant to attack and swelling in strongly alkaline solution in the case of use in the nickel/carbon hybrid supercapacitor system. The sealant material must also form a strong bond with the nickel foil based current collectors that it bridges where nickel foil is used as the external surface material.

In general, the seal is applied to the perimeter of the cell as is shown more clearly in FIG. 3.

The electrode assembly is built up within the seal perimeter. A number of materials may be used as the sealant, including, for example, curable glues and thermoplastic polymers.

Where the sealant is glue, the glue is applied to the perimeter of the current collectors, encasing the cell components within. The glue is then cured under the appropriate conditions to give a fully sealed cell. The sealed cell can then be electrochemically cycled to ‘form’ it ready for use. Under some circumstances the formation process results in gas generation on the electrodes due to electrolysis of water. In this case it is necessary to carry out formation on a partially sealed cell in order not to accumulate gas in the cell and to allow replenishment of lost water if required, followed by completion of the seal. Here, fabrication proceeds with the sealing of two or three sides of the cell, followed by formation and electrolyte replenishment and then sealing of the remaining one or two sides. Alternatively, all four sides of the cell are sealed such that the cell components are sealed to one of the current collectors but leaving the final current collector unattached. This ‘open sandwich’ is then formed, water is replenished if required and glue is again used to seal the final current collector to the assembly. A suitable glue is DP-190 epoxy from 3M.

The gluing method suffers a drawback in that most suitable glues take minutes or hours to cure. Depending on the scale of production this can make the cost of manufacture prohibitive. In high volume manufacture it is desirable to use processes that take seconds rather than minutes or hours to carry out. To address this issue a thermoplastic polymer gasket may be used.

Heat is applied to the perimeter of the cell where the gasket is located as shown by the arrows 12, 13, 14, 15 in FIG. 4.

The process is represented schematically in FIG. 5.

1. In a first step [FIG. 5(a)], a gasket 17 or 18, formed from a thermoplastic polymer, is glued, using glue 16, to a nickel foil 3 or 4, to give a composite.
2. In a second step [FIGS. 5(b) and 5(c)], cell components, e.g. electrode 19 or 20 and separator 21, are built up inside the gasket area of both pieces.
3. in a final step, the separate cell pieces are bonded at 22 by joining the aligned polymer sections, thus sealing the cell.

Since the polymer gaskets are thermoplastic, the polymer/polymer bond can be carried out in seconds either with the direct application of heat to the interface or via methods in which heat is applied indirectly such as in ultrasonic welding. In addition to much shorter processing time, this route has the advantage that the polymer/polymer bond is far more reliable than a metal/polymer bond and is therefore less likely to fail when used as a final step in the process.

In order to form the composite of Step 1, the above method still requires a gluing step with curing times of minutes or hours. However, using this method, the time consuming gluing step may be carried out separately to the very time sensitive cell assembly/sealing steps in an upstream process. This decoupling ensures that Steps 2 and 3 are carried out rapidly. Step 1 could be carried out economically if processing were based on a continuous methodology.

Suitable polymers include thermoplastic materials that do not swell or corrode significantly in the presence of electrolytes. Such materials include polypropylene, polyethylene, acetal, polyvinylidene difluoride and nylon. Suitable glues include those that do not swell or corrode significantly in the presence of electrolytes such as the alkaline solutions used in some hybrid supercapacitors or in organic solvents such as those used in lithium ion batteries or conventional double layer supercapacitors. Such glues include 3M's DP-190 epoxy.

FIG. 6 shows a smart card 23, containing two electrochemical cells 24 and 25. The cells are within the walls 26 and 27 of the smart card 23. The outer sides 28 and 29 of the electrochemical cells 24 and 25 are in physical and electrical contact with the walls 26 and 27 of the smart card 23, or in electrical contact with plates or contacts (not shown) on the inside of those walls. The inner sides of the electrochemical cells 24 and 25 are similarly in physical and electrical contact with each other.

FIG. 7 shows an embodiment in which the cell is encased in conducting plastic z4z. As before, the cell comprises a positive mesoporous nickel electrode 1, a carbon negative electrode 2, current collectors 3 and 4 and a separator 5. Polypropylene gaskets 31 seal each end of the cell.

FIG. 8 shows a cross sectional view of an alternative design of electrochemical cell, in which a titanium nitride layer 33 is provided between the positive electrode 1 and a polypropylene film 32 glued to that TiN layer. Polypropylene gaskets 31 seal each end of the cell.

The invention is further illustrated by the following non-limiting Example.

### EXAMPLE 1

### Compressible Supercapacitor Assembly and Testing

To make the hybrid supercapacitor a nanostructured nickel cobalt electrode was combined with a polypropylene separator (Celgard 3501) and a 250 μm carbon electrode (Gore Excellorator) and 6M KOH (electrolyte). The current collector for the carbon electrode, made of 10 μm nickel foil, was coated with conductive adhesive to make it impervious to the electrolyte of the cell, but remain electronically conductive. The nanostructured nickel cobalt electrode, the carbon electrode and the separator all had the same footprint.

Once assembled together with the polypropylene gaskets as described above, the device was heat moulded to hermetically seal the materials together, totally encasing the electrodes.

The cell was found to be effectively reversibly compressible. At 74 gm-force/cm² it suffered a 7% reversible reduction in thickness from 321 to 300 micron.

At 573 gm-force/cm² the cell suffered a 38% reversible reduction in thickness. These pressures are well within the range of commercial smart-card laminating machines and technology. See for example Wuhan Wenlin Technology Co. Ltd of China's WL-FA 1000 laminator which has a working pressure of 4.5 MegaPascal (45.9*10³ gm-force/square centimetre). The cell, once compressed by 38% was found to exhibit excellent performance when contacted across the two external surfaces of the nickel current collectors.

### EXAMPLE 2

### Electrochemical Cell Glued and Heat Sealed with External Sealants and Two-Layer Current Collectors

A 3 cm by 3 cm square shaped frame of thin heat sealable polypropylene film 30 μm thick with a square cavity 1.5 cm by 1.5 cm cut from the centre was glued with an adhesive compatible with KOH solution to a 2 cm by 2 cm square sheet of 10 μm thick nickel foil. The two pieces were aligned such that the ‘hole’ in the polypropylene film allowed later electrical contact with the underlying nickel foil and so that the polypropylene extended over the edges of the nickel foil to allow subsequent heat sealing. In order to improve the adhesion of the adhesive to the nickel, the nickel was coated on the side to be glued with a sputtered titanium nitride layer of 3 μm thickness prior to gluing.

The glued assembly was then cured at 80° C.

Once the glue had been fully cured, a 2 cm by 2 cm nanostructured nickel electrode deposited previously onto a nickel foil was placed onto the nickel foil side of the glued assembly. A 2 cm by 2 cm piece of polypropylene separator (Celgard 3501) was then placed on top of the nanostructured nickel electrode. A 3 cm by 3 cm square frame polypropylene gasket with 2 cm by 2 cm internal dimensions was then added to the stack so that the internal dimensions aligned with the footprint of the nanostructured nickel electrode. Within the cavity of the polypropylene gasket was placed a 2 cm by 2 cm activated carbon electrode attached using conductive adhesive to a nickel foil current collector. The electrode assembly was then dosed with 6 M KOH electrolyte and a second glued assembly was placed on top of the stack so that the nickel foil part of the glued assembly was in contact with the nickel foil current collector of the carbon electrode.

A square shaped heating element was then applied to the edges of the stack just outside the perimeter of the electrode assembly in order to heat seal the polypropylene and thereby seal the electrode assembly. Once complete, the sealed cell was connected with a potentiostat and electrochemically conditioned to ready it for operation.

A schematic representation of this cell is shown in FIG. 9 of the accompanying drawings, with positive electrode 1, negative electrode 2, current collectors 3a, 3b, 4a, 4b, separator 5, polypropylene gaskets 31, TiN layers 33, glue 35 and heat sealable film 36.

### EXAMPLE 3

Electrochemical cell glued and heat sealed with external sealants and single-layer current collectors.

A 3 cm by 3 cm square shaped frame of thin heat sealable polypropylene film 30 μm thick with a square cavity 1.5 cm by 1.5 cm cut from the centre was glued with an adhesive compatible with KOH solution to a 2 cm by 2 cm square sheet of 10 μm thick nickel foil onto which was deposited a layer of nanostructured nickel electrode material on one side and a 3 μm thick layer of sputtered titanium nitride on the other side. The pieces were glued so that the glue was in contact with the titanium nitride coated side of the nickel foil. The two pieces were aligned such that the cavity in the polypropylene film allowed later electrical contact with the underlying nickel foil and so that the polypropylene extended over the edges of the nickel foil to allow subsequent heat sealing. The glued assembly was then cured at 80° C.

A 2 cm by 2 cm piece of polypropylene separator (Celgard 3501) was then placed on top of the nanostructured nickel electrode. A 3 cm by 3 cm square frame polypropylene gasket with 2 cm by 2 cm internal dimensions was then added to the stack so that the internal dimensions aligned with the footprint of the nanostructured nickel electrode. The electrode/separator assembly was then dosed with 6 M KOH electrolyte. Within the cavity of the polypropylene gasket was then placed an assembly consisting of a 2 cm by 2 cm activated carbon electrode attached using conductive adhesive to a nickel foil current collector which was in turn glued to a 3 cm by 3 cm 30 μm thick polypropylene film with a central 1.5 cm by 1.5 cm cavity.

A square shaped heating element was then applied to the edges of the stack just outside the perimeter of the electrode assembly in order to heat seal the polypropylene and thereby seal the electrode assembly. Once complete, the sealed cell was connected with a potentiostat and electrochemically conditioned to ready it for operation.

A schematic representation of this cell is shown in FIG. 10 of the accompanying drawings, with positive electrode 1, negative electrode 2, current collectors 3, 4, separator 5, polypropylene gaskets 31, TiN layers 33, glue 35 and heat sealable film 36.

### EXAMPLE 4

Electrochemical cell glued and heat sealed with external sealants and single-layer current collectors with no gasket material and extended separator.

A 3 cm by 3 cm square shaped frame of thin heat sealable polypropylene film 30 μm thick with a square cavity 1.5 cm by 1.5 cm cut from the centre was glued with an adhesive compatible with KOH solution to a 2 cm by 2 cm square sheet of 10 μm thick nickel foil onto which was deposited a layer of nanostructured nickel electrode material on one side and a 3 μm thick layer of sputtered titanium nitride on the other side. The pieces were glued so that the glue was in contact with the titanium nitride coated side of the nickel foil. The two pieces were aligned such that the cavity in the polypropylene film allows later electrical contact with the underlying nickel foil and so that the polypropylene extends over the edges of the nickel foil to allow subsequent heat sealing. The glued assembly was then cured at 80° C.

A 2.5 cm by 2.5 cm piece of polypropylene separator (Celgard 3501) was then placed centrally on top of the nanostructured nickel electrode. The electrode/separator assembly was then dosed with 6 M KOH electrolyte. On top of the separator was then placed an assembly consisting of a 2 cm by 2 cm activated carbon electrode attached using conductive adhesive to a nickel foil current collector which was in turn glued to a 3 cm by 3 cm 30 μm thick polypropylene film with a central 1.5 cm by 1.5 cm cavity.

A square shaped heating element was then applied to the edges of the stack just outside the perimeter of the electrode assembly in order to heat seal the polypropylene and thereby seal the electrode assembly. Once complete, the sealed cell was connected with a potentiostat and electrochemically conditioned to ready it for operation.

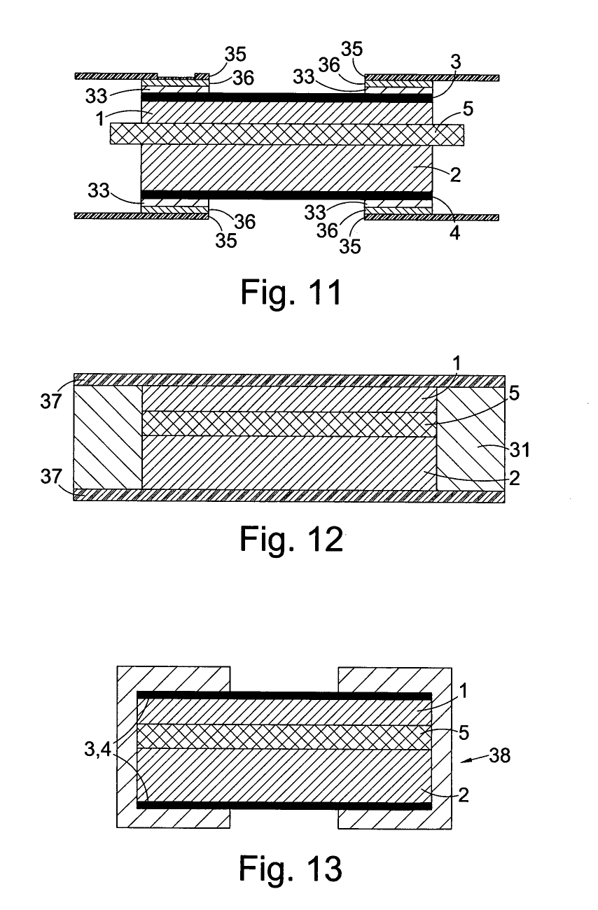

A schematic representation of this cell is shown in FIG. 11 of the accompanying drawings, with positive electrode 1, negative electrode 2, current collectors 3, 4, separator 5, polypropylene gaskets 31, TiN layers 33, glue 35 and heat sealable film 36.

### EXAMPLE 5

### Electrochemical Cell Using Conducting Plastic as the External Terminals

A 2 cm by 2 cm nanostructured nickel electrode supported on a nickel foil current collector was placed on top of a 3 cm by 3 cm sheet of 50 μm thick conducting plastic composed of graphite particles in a polypropylene matrix. Then a 2 cm by 2 cm polypropylene separator (Celgard 3501) was placed on top of the nickel electrode. Over the separator was then placed a 3 cm by 3 cm polypropylene gasket with a 2 cm by 2 cm cavity cut from the centre.

Into the cavity of the gasket was placed a 2 cm by 2 cm activated carbon electrode which was attached to a 10 μm thick nickel foil using a conductive adhesive. 6 M KOH electrolyte was dosed onto the electrode assembly stack. To complete the stack a second piece of 3 cm by 3 cm conducting plastic was placed centrally over the carbon electrode and its current collector.

A square shaped heating element was then applied to the edges of the stack just outside the perimeter of the electrode assembly in order to heat seal the polypropylene and thereby seal the electrode assembly. Once complete, the sealed cell was connected with a potentiostat and electrochemically conditioned to ready it for operation.

A schematic representation of this cell is shown in FIG. 12 of the accompanying drawings, with positive electrode 1, negative electrode 2, separator 5, polypropylene gaskets 31, and conducting heat sealable plastic layer 37.

### EXAMPLE 6

### Electrochemical Cell Using Conducting Plastic as the External Terminals-Different Conducting Plastic

A 2 cm by 2 cm nanostructured nickel electrode supported on a nickel foil current collector was placed on top of a 3 cm by 3 cm sheet of 100 μm thick conducting plastic composed of nickel mesh embedded in a polyvinylidene difluoride (PVDF) matrix. Then a 2 cm by 2 cm polypropylene separator (Celgard 3501) was placed on top of the nickel electrode. Over the separator was then placed a 3 cm by 3 cm PVDF gasket with a 2 cm by 2 cm cavity cut from the centre.

Into the cavity of the gasket was placed a 2 cm by 2 cm activated carbon electrode which was attached to a 10 μm thick nickel foil using a conductive adhesive. 6 M KOH electrolyte was dosed onto the electrode assembly stack. To complete the stack a second piece of 3 cm by 3 cm conducting plastic was placed centrally over the carbon electrode and its current collector.

A square shaped heating element was then applied to the edges of the stack just outside the perimeter of the electrode assembly in order to heat seal the polypropylene and thereby seal the electrode assembly. Once complete, the sealed cell was connected with a potentiostat and electrochemically conditioned to ready it for operation.

A schematic representation of this cell is shown in FIG. 12 of the accompanying drawings, with positive electrode 1, negative electrode 2, separator 5, polypropylene gaskets 31, and conducting heat sealable plastic layer 37.

### EXAMPLE 7

### Electrochemical Cell Using Conducting Plastic as the External Terminals-Extended Separator, No Gasket

A 2 cm by 2 cm nanostructured nickel electrode supported on a nickel foil current collector was placed on top of a 3 cm by 3 cm sheet of 50 μm thick conducting plastic composed of graphite particles in a polypropylene matrix. Then a 2.7 cm by 2.7 cm polypropylene separator (Celgard 3501) was placed centrally on top of the nickel electrode.

Onto the separator was placed a 2 cm by 2 cm activated carbon electrode which was attached to a 10 μm thick nickel foil using a conductive adhesive. 6 M KOH electrolyte was then dosed onto the electrode assembly stack. To complete the stack a second piece of 3 cm by 3 cm conducting plastic was placed centrally over the carbon electrode and its current collector.

A square shaped heating element was then applied to the edges of the stack just outside the perimeter of the electrode assembly in order to heat seal the polypropylene and thereby seal the electrode assembly. Once complete, the sealed cell was connected with a potentiostat and electrochemically conditioned to ready it for operation.

### EXAMPLE 8

### Electrochemical Cell with Adhesive Encapsulated Perimeter

A 2 cm by 2 cm nanostructured nickel electrode was assembled with a 2 cm by 2 cm Celgard 3501 polypropylene separator and a 2 cm by 2 cm carbon electrode such that the electrodes were sandwiching the separator. Both electrodes were mounted onto 10 μm thick nickel foil current collectors. The assembly was then impregnated with 6M KOH electrolyte.

The assembly was then placed into a 2.2 cm by 2.2 cm prismatic mould made of polytetrafluoroethylene (PTFE) that contained two vertically opposed 1.7 cm by 1.7 cm square feet protruding into the mould cavity. The assembled cell was held such that it was held firmly between the opposing feet with only the edges of the cell exposed. The mould was then filled up with an adhesive compatible with KOH solution. After the adhesive had cured, the mould was opened and the cell extracted.

Once extracted, the sealed cell was connected with a potentiostat and electrochemically conditioned to ready it for operation.

A schematic representation of this cell is shown in FIG. 13 of the accompanying drawings, with positive electrode 1, negative electrode 2, current collectors 3, 4, separator 5, and encapsulating adhesive 38.

1. An electrochemical cell comprising electrodes, electrolyte and a separator, characterised in that the cell is compressible under a pressure not exceeding 100 MegaPascal to reduce reversibly the cell thickness, such that the total cell thickness is reduced by the compression by at least 5%, and that at least two external surfaces of the cell, electrically insulated from each other, are electrically conducting and are, or are in electrical contact with, respective electrodes and the cell is sealed by an impermeable, electrically non-conducting polymeric material.

2. An electrochemical cell according to claim 1, in which the cell is compressible under a pressure not exceeding 100 MegaPascal to reduce reversibly its thickness by at least 10%.

3. An electrochemical cell according to claim 1, in which the cell is compressible under a pressure not exceeding 20 MegaPascal to reduce reversibly its thickness by at least 5%.

4. An electrochemical cell according to claim 3, in which the cell is compressible under a pressure not exceeding 20 MegaPascal to reduce reversibly its thickness by at least 10%.

5. An electrochemical cell according to claim 3, in which the cell is compressible under a pressure not exceeding 4.5 MegaPascal to reduce reversibly its thickness by at least 5%.

6. An electrochemical cell according to claim 5, in which the cell is compressible under a pressure not exceeding 4.5 MegaPascal to reduce reversibly its thickness by at least 10%.

7. An electrochemical cell according to claim 3, in which the cell is compressible under a pressure not exceeding 1 MegaPascal to reduce reversibly its thickness by at least 5%.

8. An electrochemical cell according to claim 3, in which the cell is compressible under a pressure not exceeding 500,000 Pascal to reduce reversibly its thickness be at least 5%.

9. An electrochemical cell according to claim 3, in which the cell is compressible under a pressure not exceeding 100,000 Pascal to reduce reversibly its thickness be at least 5%.

10. An electrochemical cell according to claim 3, in which the cell is compressible under a pressure not exceeding 50,000 Pascal to reduce reversibly its thickness be at least 5%.

11. An electrochemical cell according to claim 3, in which the cell is compressible under a pressure not exceeding 10,000 Pascal to reduce reversibly its thickness by at least 5%.

12. An electrochemical cell according to claim 3, in which the cell is compressible under a pressure not exceeding 10,000 Pascal to reduce reversibly its thickness by at least 10%.

13. An electrochemical cell according to claim 1, in which the total electrochemical cell thickness is no greater than 1 mm.

14. An electrochemical cell according to claim 13, in which the total thickness of the electrochemical cell or cells is no greater than 600 μm.

15. A smart card having a power source which comprises at least one electrochemical cell according to claim 1.

16. A smart card according to claim 15, in which the card collects power from the electrochemical cell or cells via plates in contact with the external surfaces of the cell or the outermost external surfaces of the cells where said plates form at least a partial covering of the walls of the void in the card used to accommodate the cell or cells.

17. An electrochemical cell according to claim 1, where a layer of ceramic, graphite or oxide material is introduced between the material comprising the external cell surface and the seal material.

18. An electrochemical cell according to claim 17, in which the layer of material between the external cell surface and the seal material is titanium nitride.

19.-20. (canceled)
